(19) United States
(12) Patent Application Publication
(10) Pub. No.: US 2008/0150988 A1
(43) Pub. Date: Jun. 26, 2008

(54) IMAGE FORMING APPARATUS AND CONTROL METHOD THEREOF

(75) Inventor: Si-joong JANG, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/779,492

(22) Filed: Jul. 18, 2007

(30) Foreign Application Priority Data
Dec. 20, 2006 (KR) 10-2006-0130895

(51) Int. Cl. B41J 29/38; B41J 2/155

(52) U.S. Cl. 347/13

(57) ABSTRACT

An image forming apparatus includes an array head part which includes a plurality of printer heads arranged to have a head gap and to print a line of print data, a partition part to partition the line of print data into predetermined sections based on a number of nozzles of the respective printer heads, a storage unit in which the print data partitioned into the predetermined sections are read out and written corresponding to a memory block, and a controller to generate a write pointer or a read pointer of the memory block based on the head gap of the respective printer heads.

### CROSS-REFERENCE TO RELATED APPLICATIONS

This application claims priority under 35 U.S.C. § 119(a) from Korean Patent Application No. 10-2006-0130895, filed on Dec. 20, 2006 in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus which conveniently controls a printing time of printing heads and efficiently arranges a needed memory block, and control method thereof.

2. Description of the Related Art

A conventional ink jet printer, which is a particular type of image forming apparatus, is a non-impact printer which performs a printing operation by thinly spraying an ink onto a sheet of paper. Also, the ink jet printer makes less noise and is more reliable than a dot-matrix printer. The ink jet printer is connected to a host computer and receives print data through an interface.

If the host computer receives a print command through a user input part, the host computer converts a print object document into the print data by a printer driver, and transmits the print data to the ink jet printer through a Universal Serial Bus (USB) or a parallel port interface. The ink jet printer saves the input print data in a memory, supplies the saved print data to a head formatter, synchronizes the print data with a print synchronizing signal output from a motor, and transmits the synchronized print data and a control signal to a printer head. Next, the printer head sprays ink through a nozzle by receiving an electric signal from the head formatter so as to perform printing.

A need for a faster printing method has resulted in a method to print entire individual lines of data all at once. FIGS. 1 and 2 illustrate examples of conventional array head parts of the conventional image forming apparatus to. FIG. 1 illustrates a first example of a conventional array head part where respective printer heads are arrayed to print a plurality of colors simultaneously, and FIG. 2 illustrates a second example of a conventional array head part where one printer head is arranged to print one color.

However, as illustrated in FIGS. 1 and 2, if the printer heads are arrayed in an array formation to make the ink jet printer fast and highly efficient, positions of data that is to be printed by the printer heads is not identical, and the positions of the data that is supposed to be printed per each color in a particular printer head area are not identical to each other according to a particular time. Accordingly, a conventional method to control the printer heads has difficulty in controlling the plurality of printer heads illustrated in FIGS. 1 and 2. Also, it is difficult to make the ink jet printer print quickly according to the above conventional method.

### SUMMARY OF THE INVENTION

The present general inventive concept provides an image forming apparatus which is capable of easily adjusting a print time of respective printer heads arranged to have a head gap, and control method thereof.

The present general inventive concept also provides an image forming apparatus which adjusts a write pointer or read pointer to read and write, respectively, print data so as to efficiently arrange a needed memory block, and control method thereof.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept are achieved by providing an image forming apparatus comprising an array head part which comprises a plurality of printer heads arranged to have a head gap and to print a line of print data, a partition part to partition the line of print data into predetermined sections based on a number of nozzles of the respective printer heads, a storage unit in which the line of print data partitioned into the predetermined sections is read out and written corresponding to a memory block, and a controller to generate a write pointer or a read pointer of the memory block based on the head gap of the respective printer heads.

The respective heads may comprise a plurality of nozzle lines, and the controller may generate the write pointer or the read pointer of the memory block based on the head gap of the respective printer heads and a nozzle gap of the respective nozzle lines.

A size of the memory block may be set based on the head gap of the respective printer heads and the nozzle gap of the respective nozzle lines.

The controller may generate the write pointer only corresponding to the line of print data to be written, and may generate the read pointer based on the head gap of the respective printer heads and the nozzle gap of the respective nozzle lines corresponding to the line of print data to be read out.

The controller may generate the write pointer in consideration of the head gap of the respective heads and the nozzle gap of the respective nozzle lines corresponding to the line of print data to be written, and may generate the read pointer only corresponding to the line of print data to be read out.

The partition part may designate ‘0’ as the print data and may partition the print data if there is no print data in a section in which the nozzle of the printer head exists.

The partition part may partition the print data so that two printer heads adjacent to each other do not print identical print data of an overlapped section generated along a horizontal direction of the respective printer heads.

The image forming apparatus may further comprise a head formatter to output the line of print data corresponding to each printer head and nozzle read out in the storage unit to the array head part based on a print synchronizing signal.

The respective printer heads may comprise nozzles to spray every color in a vertical direction and may be arranged in a regular interval.

Each printer head may spray one color, and the printer head per color may be arranged in the vertical direction to display every color.

The foregoing and/or other aspects and utilities of the present general inventive concept may also be achieved by providing a control method of an image forming apparatus comprising an array head part including a plurality of printer heads arranged to have a head gap and print a line of print data, the control method comprising partitioning the line of print data into predetermined sections based on a number of nozzles of the respective printer heads, and generating a write pointer or a read pointer to write or read out the line of print data partitioned into the predetermined sections per a memory block based on a size of the head gap of the respective printer heads.

The respective printer heads may comprise a plurality of nozzle lines, and the generating of the write pointer or the read pointer may comprise generating the write pointer or the read pointer of the memory block based on the head gap of the respective printer heads and the nozzle gap of the respective nozzle lines.

The partitioning of the predetermined sections may comprise partitioning after designating ‘0’ as the print data if there is no print data in a section in which the nozzle of the printer head exists.

The partitioning of the predetermined sections may comprise partitioning the line of print data so that two printer heads adjacent to each other do not print identical print data of an overlapped section generated along a horizontal direction of the respective printer heads.

The control method of the image forming apparatus may further comprise setting a size of the memory block based on the head gap of the respective printer heads and the nozzle gap of the respective nozzle lines.

The control method of the image forming apparatus may further comprise outputting the line of print data per printer head and nozzle read out in the storage to the plurality of printer heads according to a print synchronizing signal.

The generating of the write pointer or the read pointer may comprise generating the write pointer only corresponding to the line which is supposed to be written and the read pointer based on the head gap of the respective printer heads and the nozzle gap of the respective nozzle lines corresponding to the line of print data to be read out.

The generating of the write pointer or the read pointer comprises generating the write pointer based on the head gap of the respective printer heads and the nozzle gap of the respective nozzle lines corresponding to the line of print data to be written, and generating the read pointer only corresponding to the line of print data to be read out.

The foregoing and/or other aspects and utilities of the present general inventive concept may also be achieved by providing an image forming apparatus, comprising an array head part comprising a plurality of printer heads to print a line of print data, and a partition part to partition the line of print data so that two printer heads adjacent to each other do not print identical print data in a section where the two printer heads overlap.

The plurality of printer heads may each comprise a plurality of nozzle lines and a head gap.

The image forming apparatus may further comprise a controller to generate a write pointer or a read pointer based on the head gap of the respective printer heads and a nozzle gap of the respective nozzle lines to store the partitioned print data in a plurality of memory blocks.

The image forming apparatus may further comprise a storage unit to store data corresponding to the partitioned print data, and a controller to distinguish and assign the partitioned print data to each of the printer heads and to store the distinguished print data in the storage unit.

The controller may comprise a data writer to distinguish the partitioned print data by assigning particular ink colors to corresponding printer heads, and a data reader to read out the partitioned print data of each of the corresponding printer heads and ink colors to control the printer heads to simultaneously spray ink.

The foregoing and/or other aspects and utilities of the present general inventive concept may also be achieved by providing an image forming apparatus, comprising an array head part comprising a plurality of printer heads to print a line of print data, a partition part to partition the line of print data into a number of predetermined sections, and a controller to assign particular ink colors to particular printer heads according to the partitioned print data to control the printer heads to simultaneously spray ink.

The print data may be partitioned to prevent the ink from being sprayed by two different printer heads in a same location twice during one printing operation.

The foregoing and/or other aspects and utilities of the present general inventive concept may also be achieved by providing a control method of an image forming apparatus comprising an array head part including a plurality of printer heads, the control method comprising partitioning print data so that two printer heads adjacent to each other do not print identical print data in a section where the two printer heads overlap.

The plurality of printer heads may each comprise a plurality of nozzle lines and a head gap.

The control method may further comprise generating a write pointer or a read pointer based on the head gap of the respective printer heads and a nozzle gap of the respective nozzle lines to store the partitioned print data in a plurality of memory blocks.

The control method may further comprise distinguishing and assigning the partitioned print data to each of the printer heads; and storing the distinguished print data in a storage unit.

The control method may further comprise distinguishing the partitioned print data by assigning particular ink colors to corresponding printer heads, and reading out the partitioned print data of each of the corresponding printer heads and ink colors to control the printer heads to simultaneously spray ink.

The foregoing and/or other aspects and utilities of the present general inventive concept may also be achieved by providing a control method of an image forming apparatus comprising an array head part including a plurality of printer heads, the control method comprising partitioning the line of print data into a number of predetermined sections, and assigning particular ink colors to particular printer heads according to the partitioned print data to control the printer heads to simultaneously spray ink.

The print data may be partitioned to prevent the ink from being sprayed by two different printer heads in a same location twice during one printing operation.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates a conventional array head part of a conventional image forming apparatus according to an exemplary embodiment of the present general inventive concept;

FIG. 2 illustrates a conventional array head part of a conventional image forming apparatus according to another exemplary embodiment of the present general inventive concept;

FIG. 3 is a block diagram of a configuration of an image forming apparatus according to an exemplary embodiment of the present general inventive concept;

FIG. 4 illustrates a function of a partition part of an image forming apparatus according to an exemplary embodiment of the present general inventive concept;

FIG. 5 illustrates a configuration of a storage unit according to an exemplary embodiment of the array head part of FIG. 1;

FIG. 6 illustrates a configuration of a storage unit according to an exemplary embodiment of the array head part of FIG. 2;

FIG. 7 illustrates a head gap and a nozzle gap according to an exemplary embodiment of the array head part of FIG. 1; and

FIG. 8 is a flowchart illustrating a control method of an image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

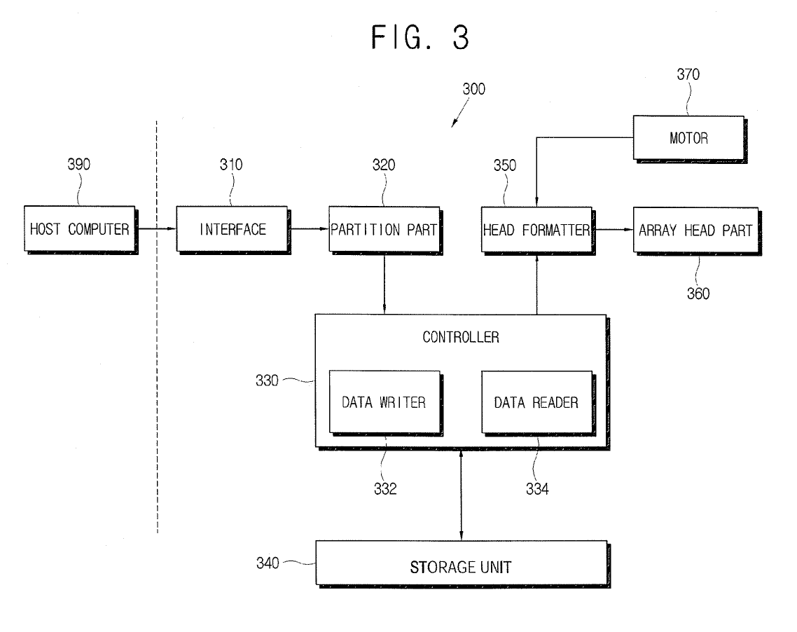

As illustrated in FIG. 3, an image forming apparatus 300 forms an image on a print medium, and includes an interface 310, a partition part 320, a controller 330, a storage unit 340, a head formatter 350, an array head part 360 and a motor 370.

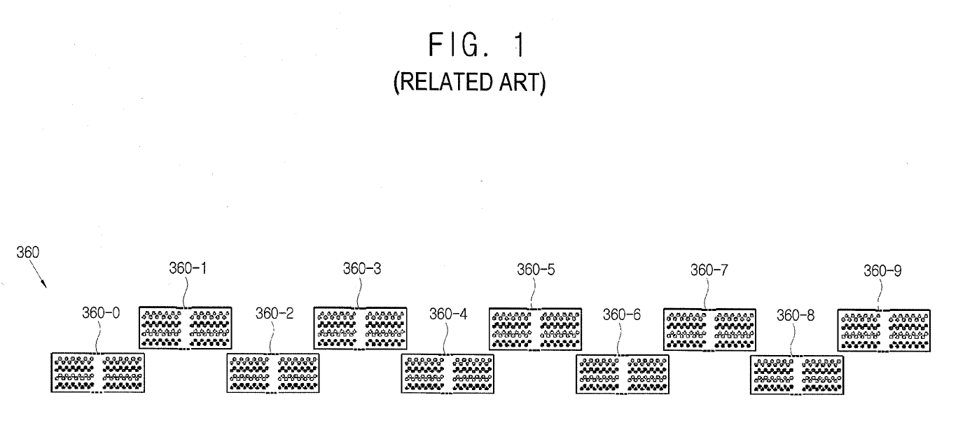

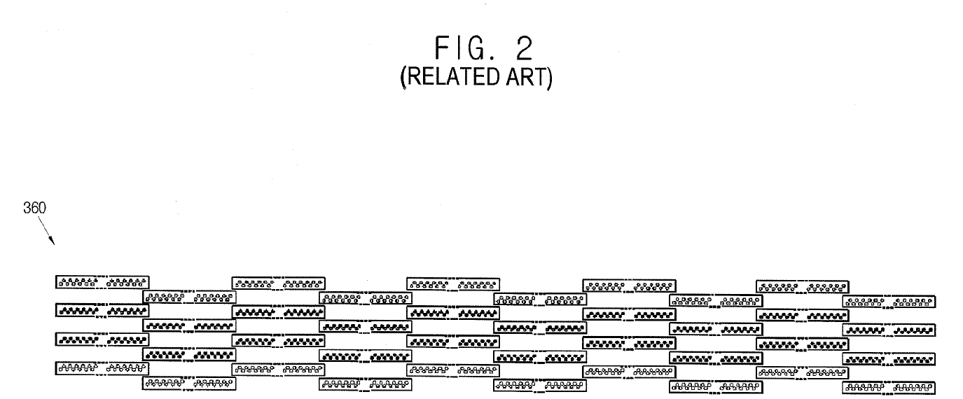

The array head part 360 includes a plurality of printer heads which are arrayed to have a head gap and print a line of print data. Examples of the array head part 360 of the image forming apparatus 300 according to an exemplary embodiment of the present general inventive concept are illustrated in FIGS. 1 and 2. The array head part 360 illustrated in FIG. 1 includes 10 printer heads 360-0 to 360-9, and the respective printer heads include nozzles to spray a plurality of colors in a vertical direction and which are arrayed in a regular gap. In other words, each head includes nozzles which can spray ink of colors including yellow Y, magenta M, cyan C and black K.

The array head part 360 illustrated in FIG. 2 includes 40 printer heads, and the printer heads are arranged so that each printer head prints one color. In other words, the respective printer heads include nozzles which spray ink of one color, including one of either yellow Y, magenta M, cyan C and black K, and printer heads of each color are arranged in a vertical direction.

The interface 310 receives the print data from a host computer 390. The interface 310 may include a decoder to decode compressed print data. The interface 310 outputs the received print data to the partition part 320.

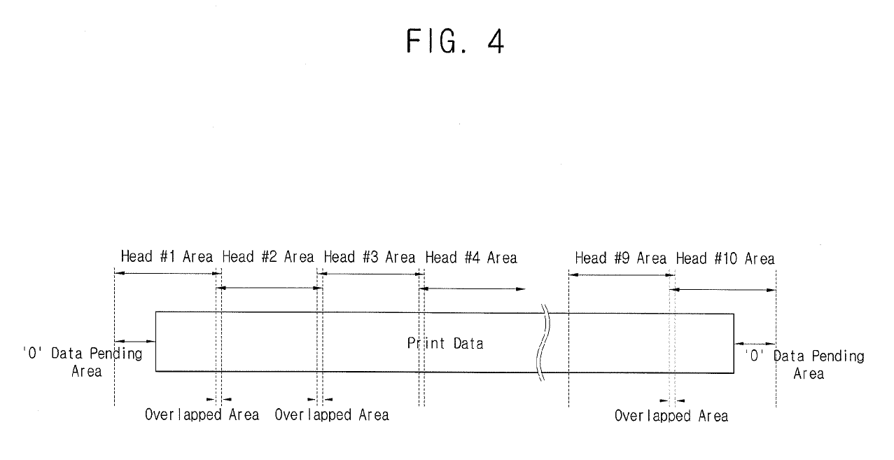

The partition part 320 partitions the print data into predetermined sections according to a number of the nozzles per printer head. A partition method to partition the predetermined sections in FIG. 4 partitions the print data based on the number of the nozzles of the respective printer heads. In other words, the print data is partitioned into the predetermined sections based on the array of the plurality of printer heads and the number of the nozzles of the respective printer heads in the array head part 360 illustrated in FIGS. 1 and 2. FIG. 4 illustrates that the line print data is partitioned to the predetermined sections having identical lengths, and one line of print data is partitioned into 10 separate areas to correspond to a number of the printer heads.

As illustrated in FIG. 4, if there is no print data in a section in which the nozzles of the first printer head 360-0 and the tenth printer head 360-9 exist, the partition part 320 designates ‘0’ as the print data in that section and then partitions the print data. Also, the partition part 320 partitions the print data so that two printer heads adjacent to each other do not print identical print data with respect to an overlapped section generated along a horizontal direction of the respective printer heads.

The controller 330 generates a write pointer and a read pointer, which are needed to write and read the print data in the storage unit 340, respectively, and includes a data writer 332 and a data reader 334. Accordingly, the controller 330 generally includes a part called a writer/reader. FIG. 3 illustrates the controller 330 configured with one block, but the data writer 332 and the data reader 334 may be included in separated blocks.

The data writer 332 distinguishes the print data partitioned into the predetermined sections by assigning different colors and printer heads to each partition, and stores the distinguished print data in the storage unit 340. Also, the data reader 334 reads out the print data per printer head and color which is supposed to be sprayed from the array head part 360 simultaneously in the storage unit 340.

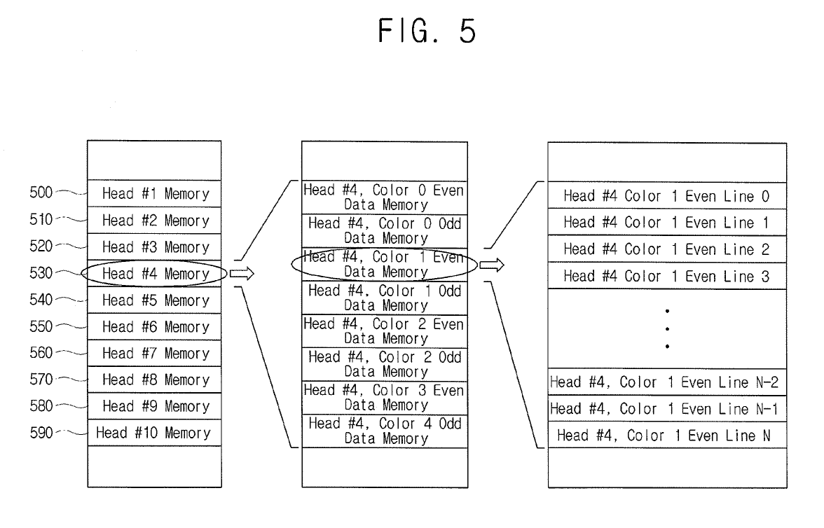

The storage unit 340 classifies the print data partitioned into the predetermined sections into each memory block and stores the classified print data. As illustrated in FIG. 5, the storage unit 340 stores the print data per printer head partitioned into the predetermined sections. Herein, the storage unit 340 stores the print data corresponding to the respective printer heads in different memory blocks. In other words, the data to be printed in the first printer head 360-0 is stored in a first printer head memory block 500 (i.e., “Head #1 Memory”), and the data to be printed in the second head 360-1 is stored in a second printer head memory block 510 (i.e., “Head #2 Memory”). Also, the print data are stored by being distinguished into the color and nozzle line in the respective memory block. In other words, the fourth printer head memory block 530 is divided according to a plurality of colors and nozzle lines included in the fourth printer head 360-3. Also, the print data of a plurality of lines is stored in a section according to each color and nozzle line.

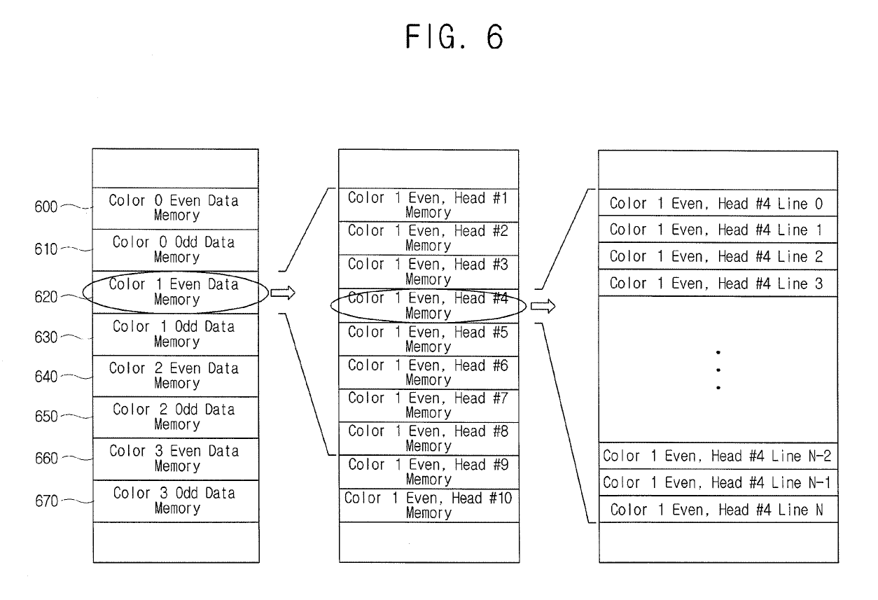

As illustrated in FIG. 6, the print data partitioned into the predetermined sections is stored per color in each memory block in the storage unit 340. In other words, data with reference to a first color and an even nozzle line is saved in a first memory block 600, and data with reference to the first color and an odd nozzle line is saved in a second memory block 610. Also, the respective memory blocks save the print data which is distinguished according to the respective printer heads. Furthermore, the sections of the respective printer heads save the print data of a plurality of the lines of print data.

The head formatter 350 outputs the data per printer head and nozzle read out in the storage unit 340 to the array head part 360 according to a print synchronizing signal.

Hereinafter, control operation of the image forming apparatus 300 according to a configuration of FIG. 3 will be described.

If a print command is input through a user input part (not illustrated), the host computer 390 outputs the print data by converting the print data into the print data having a format of Graphic Device Interface (GDI) through a printer driver (not illustrated). The print data may be received through the interface 310 of the image forming apparatus 300 through a Universal Serial Bus (USB) or a parallel port interface.

Generally, if the ink jet printer tries to print at a high speed, because a data bandwidth of the interface 310 is limited, the host computer 390 outputs the print data after compressing the print data. Here, the compressed print data is decoded according to a decoding method corresponding to a compressing method. Then, the print data is converted into printable binary data after being processed in image processing and half-toning according to necessity. Accordingly, the image forming apparatus 300 may further include a decoder and an image processor.

The print data are partitioned by different printer heads and colors in the partition part 320. FIG. 4 is a diagram illustrating a data partition method.

As mentioned above, an embodiment of the present general inventive may designate ‘0’ as the data in a printer head section which does not include the print data to make the number of the nozzles of the printer head identical to the number of the print data. For example, if the number of the nozzles per color of one printer head is 800 and the print data of a section of the first printer head 360-0 illustrated in FIG. 4 is 500, 300 ‘0’ values may be designated as the first 300 spaces of print data and may be located at a position in front of the rest of print data to make the print data correspond to 800 with consideration of the number of the nozzles (i.e., 800 nozzles) of the first printer head 360-0. According to the same method, 300 ‘0’ values may be designated as the last 300 spaces of print data and may be located at a rear portion of the print data to make the print data correspond to 800 in the tenth head 360-9. Subsequently, the print data is divided by a product of multiplying the number of the printer heads by the number of the color nozzles per each printer head. In addition, the data may be divided with consideration of a section which is overlapped along the horizontal direction of at least two respective printer heads, as illustrated by an “overlapped area” in FIG. 4. If the data is divided without consideration of the overlapped section, two overlapping printer heads print the same overlapped section twice, thereby decreasing overall image quality. Therefore, the print data is divided so that the two printer heads do not overlap each other in a situation where overlapped printing would otherwise occur.

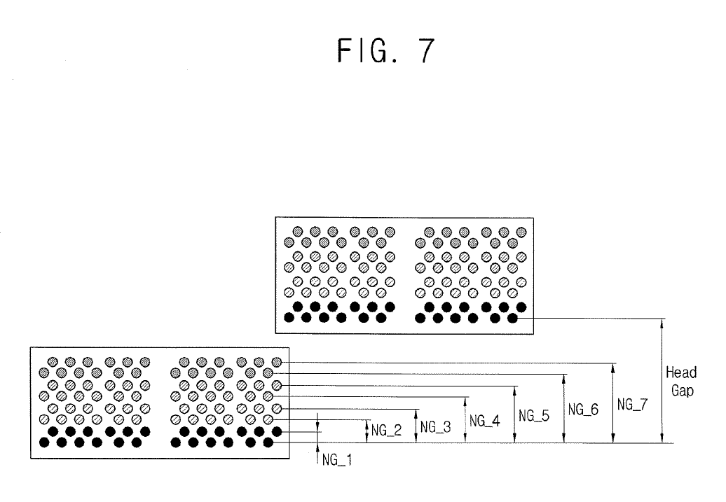

The print data divided per printer head and color is stored in the storage unit 340 by the data writer 332. Here, the storage unit 340 includes respective memory blocks corresponding to each individual printer head. Herein, a size of the memory block is set in consideration of the position of the color nozzle in a vertical direction of a plurality of printer heads and the position of the printer heads. FIGS. 5 and 6 illustrate examples of the section of the storage unit 340 which stores the print data. As illustrated in FIG. 7, if positions of the respective nozzles are NG 1 to NG 7 based on the color nozzle in the bottom line of a lower printer head, and a distance between the lower printer head and an upper printer head is HG, the size of the respective memory blocks can be calculated.

Referring to FIG. 7, if the size of the memory block saving the print data of the nozzle 0 of the lower printer head corresponds to a standard sized memory block, the size of the memory block of the nozzle n of the lower printer head is the standard size of the memory block+NGn×N, the size of the memory block of the nozzle 0 of the upper printer head is the standard size of the memory block+HG×N, and the size of the memory block of the nozzle n of the upper printer head is the size of the standard memory block+(NGn+HG)×N. Herein, n is the number of 1 to 7, and N is the number of the nozzles which are at the same position in a vertical direction in one printer head. Also, NGn is a value of the position of the nozzle in the vertical direction divided by print resolution, and HG is a value of the positions of the lower printer head and upper printer head divided by the print resolution. If the size of the respective memory block is set by the above method, the needed size of the memory block can be provided so that the memory capacity of the memory block is efficiently used.

A pointer to be saved in the storage unit 340 by the data writer 332 can be calculated by one of the two following methods.

According to a first method, the data writer 332 writes the print data in consideration of the position of the printer head and the nozzle at the time of reading the print data. In other words, the write pointer corresponding to an mth nozzle of an nth printer head is a standard address of the nth printer head+a standard address of the mth nozzle+(current line×N) mod (the size of memory of the mth nozzle of the nth printer head). Herein, N is the number of the nozzles which are in the same position in the vertical direction in one printer head, and mod is an arithmetic remainder well known in the art.

According to a second method, the data writer 332 writes the print data in consideration of the position of the printer head and the nozzle at the time of writing the print data. In other words, the write pointer for the mth nozzle of the nth printer head is the standard address of the nth printer head+the standard address of the mth nozzle+(current line+nth HG+mth NG)×N mod (the size of memory of the mth nozzle of the nth printer head). Herein, N is the number of the nozzles which are in the same position in the vertical direction in one printer head, and mod is the arithmetic remainder. Furthermore, the nth HG is a value of the position of the nth printer head divided by the print resolution based on the printer head located at the bottom, and the mth NG is a value of the position of the mth nozzle divided by the print resolution based on the nozzle located at the bottom in the vertical direction.

The data reader 334 reads out all the print data per printer head and color in the respective memory blocks at the same time according to the corresponding data writing method of the data writer 332. Also, the position supposed to be read out from each memory block by the data reader 334 may be calculated by the method corresponding to the writing method of the data writer 332.

The pointer to be read out in the storage unit 340 by the data reader 334 may be calculated by one of the following two methods.

According to a first method, the data reader 334 reads out the print data in consideration of the position of the printer head and the nozzle at the time of reading the print data. In other words, the read pointer for the mth nozzle of the nth printer head is the standard address of the nth printer head+the standard address of the mth nozzle+(current line−nth HG−mth NG)×N mod (the size of memory of the mth nozzle of the nth printer head). Herein, N is the number of the nozzles which are in the same position in the vertical direction in one printer head, and mod is the arithmetic remainder. Furthermore, the nth HG is a value of the position of the nth printer head divided by the print resolution based on the printer head located at the bottom, and the mth NG is a value of the position of the mth nozzle divided by the print resolution based on the nozzle located at the bottom in the vertical direction. Meanwhile, if the value of (current line−HG−NGn) is smaller than 0, value 0 is output to the head formatter 350 instead of reading out the data in the storage unit 340.

According to a second method, the data reader 334 reads out the print data in consideration of the position of the printer head and the nozzle at the time of writing the print data. In other words, the read pointer corresponding to the mth nozzle of the nth printer head is the standard address of the nth printer head+the standard address of the mth nozzle+(current line)×N mod (the size of memory of the mth nozzle of the nth printer head). Herein, N is the number of the nozzles which are in the same position in the vertical direction in one printer head, and mod is the arithmetic remainder.

The data per printer head and color read out in the storage unit 340 get a regular form according to a head interface standard in the head formatter 350. A control signal and the print data are transmitted to the array head part 360 by synchronizing with the print synchronizing signal output from the motor 370, and the array head part 360 sprays the ink to perform the print operation by an input electric signal.

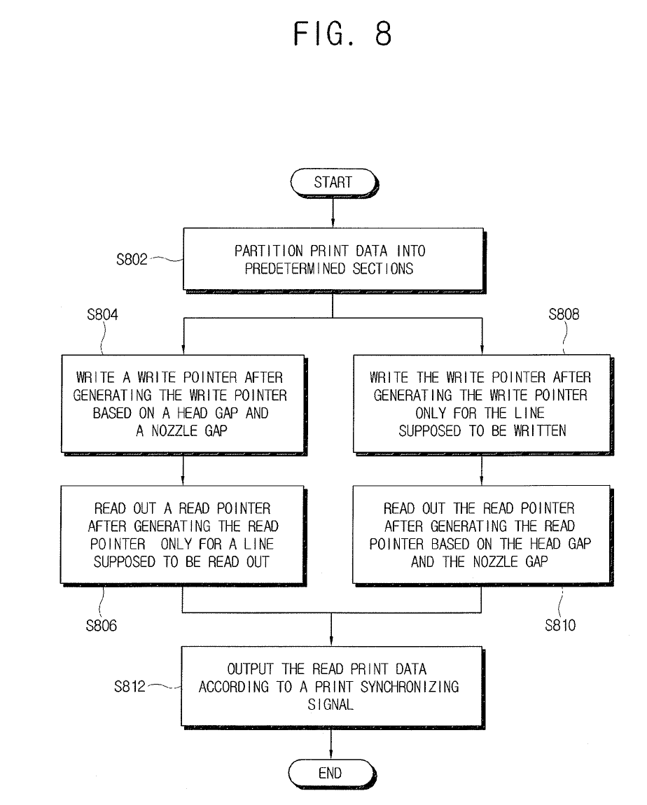

As illustrated in FIG. 8, the array head part 360 in the image forming apparatus 300 includes the plurality of printer heads arranged to have a head gap and to print the line of print data.

Referring to FIGS. 3 through 8, the host computer 390 transmits the print data to the interface 310 of the image forming apparatus 300 through the Universal Serial Bus (USB) or the parallel port interface. The interface 310 outputs the received print data to the partition part 320.

The partition part 320 partitions the print data into the predetermined sections based on the number of the nozzles of the respective printer heads in operation S802. Also, the partition part 320 designates ‘0’ as the print data and partitions the print data if there is no print data in the section in which the nozzle of the printer head exists. Accordingly, the partition part 320 partitions the print data so that two printer heads adjacent to each other do not print identical print data with respect to the overlapped section generated along the horizontal direction of the respective printer heads.

The data writer 332 generates the write pointer to write the print data divided into the predetermined sections and writes the generated write pointer per the memory block of the storage unit 340 based on the head gap of the respective printer heads and the nozzle gap of the respective nozzle lines in operation S804. Accordingly, because the data writer 332 writes the print data in the storage unit 340 based on the head gap of the respective printer heads and the nozzle gap of the respective nozzle lines, the data reader 334 generates and reads out the read pointer only corresponding to the line of print data to be read in operation S806.

However, the data writer 332 may generate and write the write pointer only corresponding to the line of print data to be written in operation S808. Accordingly, the data reader 334 generates and reads out the read pointer based on the head gap of the respective printer heads and the nozzle gap of the respective nozzle lines in operation S810.

The head formatter 350 outputs the data per printer head and nozzle, which is read out in the storage unit 340, to the array head part 360 based on the print synchronizing signal in operation S812.

As described above, an embodiment of the present general inventive concept easily adjusts a print time of respective printer heads arranged to have a head gap.

Also, an embodiment of the present general inventive concept adjusts a write pointer or a read pointer which writes or reads the print data, respectively, to arrange a memory most efficiently.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus comprising:
an array head part comprising a plurality of printer heads arranged to have a head gap and to print a line of print data;
a partition part to partition the line of print data into predetermined sections of print data based on a number of nozzles of the respective printer heads;
a storage unit in which the line of print data partitioned into the predetermined sections is read out and written corresponding to a memory block; and
a controller to generate a write pointer or a read pointer of the memory block based on the head gap of the respective printer heads.

2. The image forming apparatus according to claim 1, wherein the respective printer heads comprise a plurality of nozzle lines, and the controller generates the write pointer or the read pointer of the memory block based on the head gap of the respective printer heads and a nozzle gap of the respective nozzle lines.

3. The image forming apparatus according to claim 2, wherein a size of the memory block is set based on the head gap of the respective printer heads and the nozzle gap of the respective nozzle lines.

4. The image forming apparatus according to claim 3, wherein the controller generates the write pointer only corresponding to the line of print data to be written, and generates the read pointer based on the head gap of the respective printer heads and the nozzle gap of the respective nozzle lines corresponding to the line of print data to be read out.

5. The image forming apparatus according to claim 3, wherein the controller generates the write pointer in consideration of the head gap of the respective printer heads and the nozzle gap of the respective nozzle lines corresponding to the line of print data to be written, and generates the read pointer only corresponding to the line of print data to be read out.

6. The image forming apparatus according to claim 1, wherein the partition part designates ‘0’ as the print data and partitions the line of print data if there is no print data in a section in which the nozzle of the printer head exists

7. The image forming apparatus according to claim 6, wherein the partition part partitions the line of print data so that two heads adjacent to each other do not print identical data of an overlapped section generated along a horizontal direction of the respective heads.

8. The image forming apparatus according to claim 2, further comprising:
a head formatter to output the line of data corresponding to each printer head and nozzle read out in the storage unit to the array head part based on a print synchronizing signal.

9. The image forming apparatus according to claim 2, wherein the respective printer heads comprise:
nozzles to spray every color in a vertical direction and are arranged in a regular interval.

10. The image forming apparatus according to claim 2, wherein the each printer head sprays one color, and the head per color is arranged in the vertical direction to display every color.

11. A control method of an image forming apparatus comprising an array head part including a plurality of printer heads arranged to have a head gap and print a line of print data, the control method comprising:
partitioning the line of print data into predetermined sections based on a number of nozzles of the respective printer heads; and
generating a write pointer or a read pointer to write or read out the print data partitioned into the predetermined sections per a memory block based on a size of the head gap of the respective printer heads.

12. The control method of the image forming apparatus according to claim 11, wherein the respective printer heads comprise a plurality of nozzle lines, and the generating the write pointer or the read pointer comprises:
generating the write pointer or the read pointer of the memory block based on the head gap of the respective printer heads and the nozzle gap of the respective nozzle lines.

13. The control method of the image forming apparatus according to claim 11, wherein the partitioning the predetermined sections comprises:
partitioning after designating ‘0’ as the print data if there is no print data in a section in which the nozzle of the printer head exists.

14. The control method of the image forming apparatus according to claim 13, wherein the partitioning the predetermined sections comprises:
partitioning the line of print data so that two printer heads adjacent each other do not print identical print data of an overlapped section generated along a horizontal direction of the respective printer heads.

15. The control method of the image forming apparatus according to claim 14, further comprising:
setting a size of the memory block based on the head gap of the respective printer heads and the nozzle gap of the respective nozzle lines.

16. The control method of the image forming apparatus according to claim 11, further comprising:
reading out and writing the partitioned line of print data in a storage unit.

17. The control method of the image forming apparatus according to claim 16, further comprising:
outputting the print data per printer head and nozzle read out in the storage unit to the plurality of printer heads according to a print synchronizing signal.

18. The control method of the image forming apparatus according to claim 17, wherein the generating the write pointer or the read pointer comprises:
generating the write pointer only corresponding to the line of print data to be written and the read pointer based on the head gap of the respective printer heads and the nozzle gap of the respective nozzle lines corresponding to the line of print data to be read out.

19. The control method of the image forming apparatus according to claim 17, wherein the generating the write pointer or the read pointer comprises:
generating the write pointer based on the head gap of the respective printer heads and the nozzle gap of the respective nozzle lines corresponding to the line of print data to be written; and
generating the read pointer only corresponding to the line of print data to be read out.

20. An image forming apparatus, comprising:
an array head part comprising a plurality of printer heads to print a line of print data; and
a partition part to partition the line of print data so that two printer heads adjacent to each other do not print identical print data in a section where the two printer heads overlap.

21. The image forming apparatus of claim 20, wherein the plurality of printer heads each comprise a plurality of nozzle lines and a head gap.

22. The image forming apparatus of claim 21, further comprising:
a controller to generate a write pointer or a read pointer based on the head gap of the respective printer heads and a nozzle gap of the respective nozzle lines to store the partitioned print data in a plurality of memory blocks.

23. The image forming apparatus of claim 20, further comprising:
a storage unit to store data corresponding to the partitioned print data; and
a controller to distinguish and assign the partitioned print data to each of the printer heads and to store the distinguished print data in the storage unit.

24. The image forming apparatus of claim 23, wherein the controller comprises:
a data writer to distinguish the partitioned print data by assigning particular ink colors to corresponding printer heads; and
a data reader to read out the partitioned print data of each of the corresponding printer heads and ink colors to control the printer heads to simultaneously spray ink.

25. An image forming apparatus, comprising:
an array head part comprising a plurality of printer heads to print a line of print data;
a partition part to partition the line of print data into a number of predetermined sections; and
a controller to assign particular ink colors to particular printer heads according to the partitioned print data to control the printer heads to simultaneously spray ink.

26. The image forming apparatus of claim 25, wherein the print data is partitioned to prevent the ink from being sprayed by two different printer heads in a same location twice during one printing operation.

27. A control method of an image forming apparatus comprising an array head part including a plurality of printer heads, the control method comprising: partitioning print data so that two printer heads adjacent to each other do not print identical print data in a section where the two printer heads overlap.

28. The control method of claim 27, wherein the plurality of printer heads each comprise a plurality of nozzle lines and a head gap.

29. The control method of claim 28, further comprising:
generating a write pointer or a read pointer based on the head gap of the respective printer heads and a nozzle gap of the respective nozzle lines to store the partitioned print data in a plurality of memory blocks.

30. The control method of claim 27, further comprising:
distinguishing and assigning the partitioned print data to each of the printer heads; and
storing the distinguished print data in a storage unit.

31. The control method of claim 28, further comprising:
distinguishing the partitioned print data by assigning particular ink colors to corresponding printer heads; and
reading out the partitioned print data of each of the corresponding printer heads and ink colors to control the printer heads to simultaneously spray ink.

32. A control method of an image forming apparatus comprising an array head part including a plurality of printer heads, the control method comprising:
partitioning the line of print data into a number of predetermined sections; and
assigning particular ink colors to particular printer heads according to the partitioned print data to control the printer heads to simultaneously spray ink.

33. The control method of claim 25, wherein the print data is partitioned to prevent the ink from being sprayed by two different printer heads in a same location twice during one printing operation.
